(19) United States
(12) Patent Application Publication
(10) Pub. No.: US 2025/0351009 A1
(43) Pub. Date: Nov. 13, 2025

(54) METHOD AND APPARATUS FOR DETERMINING COMPUTING POWER RESOURCE, AND NETWORK SIDE DEVICE

(71) Applicant: VIVO MOBILE COMMUNICATION CO., LTD., Dongguan (CN)

(72) Inventors: Jianan CAI, Dongguan (CN); Pucong WANG, Dongguan (CN); Huazhang LV, Dongguan (CN)

(21) Appl. No.: 19/273,073

(22) Filed: Jul. 17, 2025

Related U.S. Application Data
(63) Continuation of application No. PCT/CN2024/072592, filed on Jan. 16, 2024.

(30) Foreign Application Priority Data
Jan. 18, 2023 (CN) 202310082271.5

(51) Int. Cl. H04W 28/26; H04L 43/0852

(52) U.S. Cl. CPC H04W 28/26; H04L 43/0852

(57) ABSTRACT

This application relates to the field of communication technologies, and discloses a method and an apparatus for determining a computing resource, and a network side device. The method for determining a computing resource in embodiments of this application includes: determining, by a first network element, a target computing node from at least one computing node based on delay information of the at least one computing node; and determining a computing resource reservation process based on the target computing node.

### CROSS-REFERENCE TO RELATED APPLICATIONS

This application is a bypass continuation application of International Application No. PCT/CN2024/072592, filed on Jan. 16, 2024, which claims the benefit of and priority to Chinese Patent Application No. 202310082271.5 filed on Jan. 18, 2023, the contents of both of which being incorporated by reference in their entireties herein.

### TECHNICAL FIELD

This application relates to the field of communication technologies and, more specifically, to a method and an apparatus for determining a computing resource, and a network side device.

### BACKGROUND

In the field of communications, a computing network, also referred to as a computing-aware network, is a new network architecture designed to address the growing convergence of computing and networking technologies. It enables dynamic interconnection of distributed computing resources through ubiquitous network connectivity. By allowing unified and coordinated scheduling of multidimensional resources, such as a network, storage, and computing power, the architecture supports real-time, on-demand access to computing resources across different locations. This facilitates global optimization of both connectivity and computing power within the network, ultimately delivering a consistent user experience.

### BRIEF SUMMARY

Embodiments of this application provide a method and an apparatus for determining a computing resource, and a network side device.

According to a first aspect, a method for determining a computing resource is provided, including: determining, by a first network element, a target computing node from at least one computing node based on delay information of the at least one computing node; and determining a computing resource reservation process based on the target computing node.

According to a second aspect, a method for determining a computing resource is provided, including at least one of the following: receiving, by a second network element, first information sent by a first network element, where the first information includes at least an identifier and/or a processing delay of at least one preselected computing node, and sending second information to the first network element, where the second information includes at least a node identifier and a target delay of a target computing node, and/or the second information includes a node identifier and a target delay of each preselected computing node, and the target computing node is a computing node having a minimum target delay among the at least one preselected computing node; and providing, by the second network element, delay notification information for the first network element, where the delay notification information includes a transmission delay of the computing node.

According to a third aspect, an apparatus for determining a computing resource is provided, including: a first determining module, configured to determine a target computing node from at least one computing node based on delay information of the at least one computing node; and a second determining module, configured to determine a computing resource reservation process based on the target computing node.

According to a fourth aspect, an apparatus for determining a computing resource is provided, the apparatus including a transmission module, configured to perform at least one of the following: receiving first information sent by a first network element, where the first information includes at least an identifier and/or a processing delay of at least one preselected computing node, and sending second information to the first network element, where the second information includes at least a node identifier and a target delay of a target computing node, and/or the second information includes a node identifier and a target delay of each preselected computing node, and the target computing node is a computing node having a minimum target delay among the at least one preselected computing node; and providing delay notification information for the first network element, where the delay notification information includes a transmission delay of the computing node.

According to a fifth aspect, a network side device is provided. The network side device includes a processor and a memory. The memory stores a program or an instruction executable in the processor. The program or the instruction, when executed by the processor, implements the steps of the method according to the first aspect or the second aspect.

According to a sixth aspect, a network side device is provided, including a processor and a communication interface, where the communication interface is coupled to the processor, and the processor is configured to run a program or an instruction to implement the steps of the method according to the first aspect, or implement the steps of the method according to the second aspect.

According to a seventh aspect, a wireless communication system is provided, including: a terminal and a network side device. The network side device may be configured to perform the steps of the method according to the first aspect or the second aspect.

According to an eighth aspect, a readable storage medium is provided. The readable storage medium stores a program or an instruction. The program or the instruction, when executed by a processor, implements the steps of the method according to the first aspect, or implements the steps of the method according to the second aspect.

According to a ninth aspect, a chip is provided. The chip includes a processor and a communication interface. The communication interface is coupled to the processor. The processor is configured to run a program or an instruction to implement the steps of the method according to the first aspect, or implement the steps of the method according to the second aspect.

According to a tenth aspect, a computer program product/program product is provided. The computer program/program product is stored in a storage medium. The computer program/program product is executed by at least one processor to implement the steps of the method according to the first aspect or the second aspect.

### BRIEF DESCRIPTION OF THE DRAWINGS

FIG. 1 is a schematic structural diagram of a wireless communication system according to an exemplary embodiment of this application.

FIG. 2 is a schematic flowchart I of a method for determining a computing resource according to an exemplary embodiment of this application.

FIG. 3 is a schematic flowchart II of a method for determining a computing resource according to an exemplary embodiment of this application.

FIG. 4a is a schematic diagram I of an interactive process of a method for determining a computing resource according to an exemplary embodiment of this application.

FIG. 4b is a schematic diagram II of an interactive process of a method for determining a computing resource according to an exemplary embodiment of this application.

FIG. 4c is a schematic diagram III of an interactive process of a method for determining a computing resource according to an exemplary embodiment of this application.

FIG. 5 is a schematic flowchart III of a method for determining a computing resource according to an exemplary embodiment of this application.

FIG. 6 is a schematic structural diagram I of an apparatus for determining a computing resource according to an exemplary embodiment of this application.

FIG. 7 is a schematic structural diagram II of an apparatus for determining a computing resource according to an exemplary embodiment of this application.

FIG. 8 is a schematic structural diagram of a communication device according to an exemplary embodiment of this application.

FIG. 9 is a schematic structural diagram of a network side device according to an exemplary embodiment of this application.

### DETAILED DESCRIPTION

Technical solutions in embodiments of this application are clearly described below with reference to drawings in embodiments of this application. Understandably, the described embodiments are merely some rather than all embodiments of this application. All other embodiments obtained by a person of ordinary skill in the art based on embodiments of this application fall within the protection scope of this application.

Terms “first”, “second”, and the like in the specification and the claims of this application are used to distinguish between similar objects, and are not used to describe a specific order or sequence. It should be understood that the terms used in this way may be transposed where appropriate, so that embodiments of this application may be implemented in a sequence other than those illustrated or described herein. In addition, objects defined by “first” and “second” are generally of the same class and do not limit a quantity of objects. For example, one or more first objects may be arranged. In addition, “and/or” in the specification and the claims indicates at least one of connected objects, and a character “/” generally indicates an “or” relationship between associated objects.

It should be noted that the technology described in embodiments of this application may be applied to a Long Term Evolution (LTE)/LTE-Advanced (LTE-A) system, and may be further applied to another wireless communication system, such as a Code Division Multiple Access (CDMA) system, a Time Division Multiple Access (TDMA) system, a Frequency Division Multiple Access (FDMA) system, an Orthogonal Frequency Division Multiple Access (OFDMA) system, a Single-carrier Frequency Division Multiple Access (SC-FDMA) system, and another system. Terms “system” and “network” in embodiments of this application are usually interchangeably used, and the described technology may be applied to both the system and the radio technology mentioned above, or may be applied to another system and radio technology. A New Radio (NR) system is described below for an illustrative purpose, and the term NR is used in most of the following descriptions, but the technologies may also be applied to applications other than applications of the NR system, such as a 6^{th} Generation (6G) communication system.

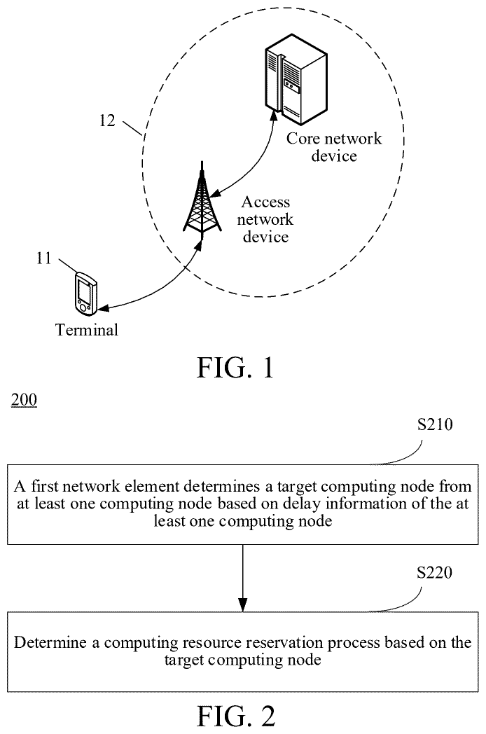

FIG. 1 is a block diagram showing a wireless communication system to which an embodiment of this application may be applied. The wireless communication system includes a user equipment 11 and a network side device 12. The terminal 11 may be a terminal side device such as a mobile phone, a tablet computer (Tablet Personal Computer), a laptop computer, which is also referred to as a notebook computer, a Personal Digital Assistant (PDA), a palm computer, a netbook, an Ultra-Mobile Personal Computer (UMPC), a Mobile Internet Device (MID), an augmented reality (AR)/virtual reality (VR) device, a robot, a wearable device, a Vehicle User Equipment (VUE), a pedestrian user equipment (PUE), smart home (a home device with a wireless communication capability, such as a refrigerator, a television, a washing machine, or furniture), a game console, a personal computer (PC), a teller machine, or a self-service machine. The wearable device includes a smart watch, a smart bracelet, a smart headset, smart glasses, smart jewelry (a smart bracelet, a smart chain bracelet, a smart ring, a smart necklace, a smart ankle bangle, a smart ankle chain, and the like), a smart wristband, smart clothing, and the like. It should be noted that a specific type of the terminal 11 is not limited in embodiments of this application. The network side device 12 may include an access network device or a core network device. The access network device 12 may also be referred to as a wireless access network device, a Radio Access Network (RAN), a wireless access network function, or a wireless access network unit. The access network device 12 may include a base station, a WLAN access point, a Wi-Fi node, and the like, The base station may be referred to as a NodeB, an evolved NodeB (eNB), an access point, a Base Transceiver Station (BTS), a radio base station, a radio transceiver, a Basic Service Set (BSS), an Extended Service Set (ESS), a household NodeB, a household evolved NodeB, a Transmitting Receiving Point (TRP), or some other appropriate term in the field, as long as the same technical effect is achieved. The base station is not limited to a specific technical term. It should be noted that, in embodiments of this application, only a base station in the NR system is used as an example, but a specific type of the base station is not limited. The core network device may include but is not limited to at least one of the following: a core network node, a core network function, a Mobility Management Entity (MME), an Access and Mobility Management Function (AMF), a Session Management Function (second network element), a User Plane Function (UPF), a Policy Control Function (PCF), a Policy and Charging Rules Function (PCRF), an Edge Application Server Discovery Function (EASDF), Unified Data Management (UDM), a Unified Data Repository (UDR), a Home Subscriber Server (HSS), a Centralized network configuration (CNC), a Network Repository Function (NRF), a Network Exposure Function NEF), a local NEF (or L-NEF), a Binding Support Function (BSF), an Application Function (AF), and the like. It should be noted that in embodiments of this application, only a core network device in the NR system is used as an example, and a specific type of the core network device is not limited.

During scheduling of computing network resources, how to further optimize the computing network resources, reduce a network delay, and improve communication performance is still a technical problem that needs to be urgently resolved in the art.

The technical solutions provided in embodiments of this application are described in detail below through some embodiments and application scenarios thereof with reference to the accompanying drawings.

As shown in FIG. 2, FIG. 2 is a schematic flowchart of a method 200 for determining a computing resource according to an exemplary embodiment of this application. The method 200 may be performed by, but not limited to, a first network element, and may be specifically performed by hardware and/or software installed in the first network element. In this embodiment, the method 200 may include at least the following steps.

S210: A first network element determines a target computing node from at least one computing node based on delay information of the at least one computing node.

The first network element may also be referred to as a computing management and computing scheduling network element (Computing resource control function, CSCF). The at least one computing node may also be referred to as a computing resource (CR), and is used for providing a computing service for a network and performing a computing task. In this embodiment, one or more computing nodes may be configured.

Based on this, in this embodiment, when determining the target computing node from the at least one computing node, the first network element may comprehensively consider a parameter, that is, the delay information of the at least one computing node, to select a computing resource having a minimum delay, thereby further optimizing computing network resources, reducing a network delay, and improving communication performance.

The delay information may be a transmission delay and/or a processing delay of the at least one computing node. In this embodiment, the processing delay may be understood as a time from a time when the at least one computing node starts to receive user data of a terminal to a time when a computing activity specified by the terminal is completed. The transmission delay may include a first interface delay and a second interface delay. In this embodiment, the first interface delay may also be referred to as an N3 interface delay, which is a transmission delay between a radio access network element (Radio Access Network, RAN, such as an NG-RAN) and a fourth network element (such as a UPF). The second interface delay may also be referred to as an N6 interface delay, which is a transmission delay between the fourth network element (such as the UPF) and the at least one computing node.

It may be understood that, in a possible implementation, when determining the target computing node, the first network element may further select the target computing node based on a computing requirement of the terminal and/or state information of the at least one computing node. The state information (or a real-time state) of the at least one computing node may include utilized resources, remaining resources, and the like of the at least one computing node. This is not limited herein. The computing requirement may be a computing resource specification, a computing resource occupation time, delay information, a service name, and a computing resource type required by the terminal. This is not limited herein.

S220: Determine a computing resource reservation process based on the target computing node.

The first network element may determine the computing resource reservation process in a plurality of manners based on the target computing node. For example, the first network element may determine the computing resource reservation process based on one or more of delay information of the at least one computing node, state information of the at least one computing node, a computing requirement of the terminal, and the like. This is not limited herein in this embodiment.

In this embodiment, the first network element determines a target computing node from at least one computing node based on the delay information of the at least one computing node, and then determines a computing resource reservation process based on the target computing node. Therefore, through comprehensive consideration of the parameter, that is, the delay information of the at least one computing node, a computing resource having a minimum delay can be further selected, thereby further optimizing the computing network resource to reduce the network delay and then improve communication performance.

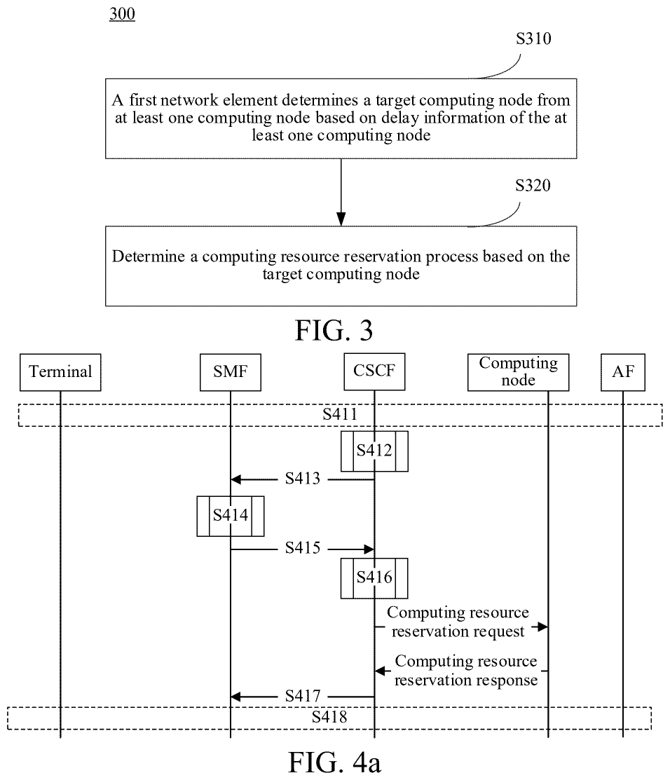

As shown in FIG. 3, FIG. 3 is a schematic flowchart of a method 300 for determining a computing resource according to an exemplary embodiment of this application. The method 300 may be performed by, but not limited to, a first network element, and may be specifically performed by hardware and/or software installed in the first network element. In this embodiment, the method 300 may include at least the following steps.

S310: A first network element determines a target computing node from at least one computing node based on delay information of the at least one computing node.

It may be understood that for an implementation process of S310, reference may be made to the related descriptions in the foregoing method embodiment 200. In a possible implementation, considering that the transmission delay of the at least one computing node is usually saved or stored in a second network element, if the delay information includes the transmission delay, the first network element may determine a determining manner of the target computing node depending on whether the transmission delay of the at least one computing node is obtained when determining the target computing node based on the delay information. In view of this, a determining process is described through an example below with reference to Implementation 1 to Implementation 3, and the content is as follows. The second network element may also be referred to as a session management function, and is configured to be responsible for tunnel maintenance, IP address allocation and management, UPF selection, control in strategy implementation and Quality of Service (QOS), charging data collection, roaming, and the like.

### Implementation 1:

Assuming that the first network element does not obtain a transmission delay of the at least one computing node, that the first network element determines the target computing node from the at least one computing node based on the delay information of the at least one computing node may include the following (11)-(15), and the content is as follows.

(11) The first network element determines at least one preselected computing node from the at least one computing node based on state information of the at least one computing node and/or a computing requirement of a terminal.

The state information of the at least one computing node may also be referred to as a real-time status of the at least one computing node, such as remaining resources, utilized resources, or the central processing unit (CPU) capacity of the at least one computing node.

The computing requirement of the terminal may be obtained by the first network element from the terminal, to provide the terminal with a computing resource suitable for a terminal requirement. In this embodiment, the computing requirement may be a computing resource specification, a computing resource occupation time, a delay requirement, a service name, a computing resource type, and the like required by the terminal. This is not limited herein.

Based on this, in an implementation, the first network element may determine the at least one preselected computing node from the at least one computing node only based on the state information of the at least one computing node, or may determine the at least one preselected computing node from the at least one computing node only based on the computing requirement of the terminal, or may determine the at least one preselected computing node based on the state information of the at least one computing node and the computing requirement of the terminal. For example, the first network element may first select one or more computing nodes based on the state information of the at least one computing node, and then determine the at least one preselected computing node from the one or more computing nodes based on the computing requirement of the terminal. For another example, the first network element may perform weighting processing on the state information of the at least one computing node and the computing requirement of the terminal, and determine the at least one preselected computing node based on a processing result. This is not limited in this embodiment.

In addition, a quantity of preselected computing nodes determined by the first network element may be set by the first network element based on a processing capability thereof. This is not limited herein.

(12) The first network element sends first information to a second network element.

The first information includes a node identifier and/or a processing delay of the at least one preselected computing node.

(13) The second network element receives the first information, and determines the at least one preselected computing node based on the first information. When the first information includes a processing delay of the at least one preselected computing node, the second network element calculates, for each preselected computing node, a target delay (which may also be referred to as an overall minimum delay or an overall delay) of the preselected computing node based on the processing delay and the transmission delay of the preselected computing node. Alternatively, when the first information does not include the processing delay of the preselected computing node, the second network element calculates a target delay of the computing node based on the transmission delay of the preselected computing node. In other words, the target delay is determined based on the transmission delay and the processing delay, or the target delay is determined based on the transmission delay. This is not limited herein. In this embodiment, the second network element may obtain the transmission delay of the preselected computing node in a manner such as a local query, for example, a first interface delay or a second interface delay.

(14) Based on a calculation result in (13), the second network element selects a computing node having a minimum target delay from at least one preselected computing node as the target computing node, and sends the second information to the first network element. The second information includes a node identifier and a target delay of the target computing node.

(15) The first network element receives second information sent by the second network element, the second information includes at least a node identifier and a target delay of the target computing node, and the target computing node is a computing node having a minimum target delay in the at least one preselected computing node. In other words, the first network element may directly determine the target computing node based on the node identifier of the target computing node carried in the second information. In other words, in this implementation, the target computing node is determined by the second network element from preselected computing nodes, and is indicated to the first network element through the second information.

In addition, in a possible implementation, the second information may further include a node identifier, a target delay, and an arrangement order of each preselected computing node. The arrangement order is determined based on magnitudes (such as in descending order or in ascending order) of the target delay. Therefore, the first network element can redetermine the target computing node based on the node identifier, the target delay, and the arrangement order of each preselected computing node, to verify whether the target computing node sent by the second network element is accurate, thereby improving accuracy of determining the target computing node.

In Implementation 1, the first network element first preselects at least one computing node, and then sends information of the at least one preselected computing node to the second network element. The second network element determines a target computing node based on a processing delay and/or a transmission delay of each preselected computing node, and finally sends the node identifier and the target delay of the target computing node to the first network element. In this way, accuracy of a computing resource determined for the terminal can be ensured, so that the overall delay of the terminal when using the computing resource is minimized.

### Implementation 2:

Assuming that the first network element does not obtain a transmission delay of at least one computing node, the process of determining the target computing node by the first network element from the at least one computing node based on the delay information of the at least one computing node may include the following (21)-(25), and the content is as follows.

(21) The first network element determines at least one preselected computing node from the at least one computing node based on state information of the at least one computing node and/or a computing requirement of a terminal.

The state information of the at least one computing node may also be referred to as a real-time status of the at least one computing node, such as remaining resources, utilized resources, or the CPU capacity of the at least one computing node.

The computing requirement of the terminal may be obtained by the first network element from the terminal, to provide the terminal with a computing resource suitable for a terminal requirement. In this embodiment, the computing requirement may be a computing resource specification, a computing resource occupation time, a delay requirement, a service name, a computing resource type, and the like required by the terminal. This is not limited herein.

Based on this, in an implementation, the first network element may determine the preselected computing node from the at least one computing node only based on the state information of the at least one computing node, or may determine the preselected computing node from the at least one computing node only based on the computing requirement of the terminal, or may determine the preselected computing node based on the state information of the at least one computing node and the computing requirement of the terminal. For example, the first network element may first select one or more computing nodes based on the state information of the at least one computing node, and then determine the preselected computing node from the one or more computing nodes based on the computing requirement of the terminal. For another example, the first network element may perform weighting processing on the state information of the at least one computing node and the computing requirement of the terminal, and determine the preselected computing node based on a processing result. This is not limited in this embodiment.

In addition, a quantity of preselected computing nodes determined by the first network element may be set by the first network element based on a processing capability thereof. This is not limited herein.

(22) The first network element sends first information to a second network element.

The first information includes a node identifier and/or a processing delay of the at least one preselected computing node. The second network element may also be referred to as a session management function, and is configured to be responsible for tunnel maintenance, IP address allocation and management, UP function selection, control in strategy implementation and QoS, charging data collection, roaming, and the like.

(23) The second network element receives the first information, and determines the at least one preselected computing node based on the first information. When the first information includes a processing delay of the at least one preselected computing node, the second network element calculates, for each preselected computing node, a target delay of the preselected computing node based on the processing delay and the transmission delay of the preselected computing node. Alternatively, when the first information does not include the processing delay of the at least one preselected computing node, the second network element calculates a target delay of the at least one preselected computing node based on the transmission delay of the at least one preselected computing node.

(24) The second network element sends second information to the first network element, where the second information includes a node identifier and a target delay of each preselected computing node. In other words, with respect to Implementation 1, in Implementation 2, the second network element does not determine a target computing node, but after calculating the target delay of each preselected computing node, sends the target delay and a corresponding node identifier of each preselected computing node to the first network element, and the first network element determines the target computing node.

Optionally, the second information includes an arrangement order of each preselected computing node, and the arrangement order is determined based on a magnitude (such as in ascending order or in descending order) of the target delay. In this way, the first network element can quickly determine the target computing node.

(25) The first network element receives the second information sent by the second network element.

When the first information includes the processing delay and the second information includes the node identifier and the target delay of each preselected computing node, a preselected computing node having a minimum target delay is determined as the target computing node. When the first information does not include the processing delay and the second information includes the node identifier and the target delay of each preselected computing node, for each preselected computing node, the target delay of the preselected computing node is updated based on a sum of the processing delay and the target delay of the preselected computing node, and the updated preselected computing node having a minimum target delay is determined as the target computing node.

In Implementation 2, the first network element first preselects at least one computing node, and then sends information of the at least one preselected computing node to the second network element. After determining a target delay of each preselected computing node based on the processing delay and the transmission delay of each preselected computing node, the second network element sends a target delay and a node identifier of each preselected computing node to the first network element. Finally, the first network element determines a target computing node based on the target delay or updated target delay of each preselected computing node. In this way, accuracy of a computing resource determined for the terminal can be ensured, so that the overall delay of the terminal when using the computing resource is minimized.

### Implementation 3:

Assuming that the first network element can obtain a transmission delay of at least one computing node, that the first network element determines the target computing node from the at least one computing node based on the delay information of the at least one computing node may include: For each computing node, the first network element determines a target delay based on the processing delay and the transmission delay of the computing node, and then directly selects, from the computing nodes, a computing node having a minimum target delay as the target computing node.

In a possible implementation, the process of obtaining the transmission delay of the at least one computing node by the first network element may include at least one of (31)-(32).

(31) When the delay information of the at least one computing node includes a transmission delay, the first network element sends a first request to the second network element, where the first request is used for subscribing to a delay notification service of the at least one computing node.

Optionally, the first request may include information such as a node identifier, a delay notification period, a first threshold, and a second threshold of the at least one computing node.

The delay notification period is used by the second network element to send a transmission delay of the at least one computing node to the first network element based on a predetermined period.

The first threshold is used for indicating that delay notification information is sent when a transmission delay variation of the at least one computing node exceeds the first threshold.

The second threshold is used for indicating that delay notification information is sent when the transmission delay of the at least one computing node exceeds the second threshold.

The delay notification period, the first threshold, and the second threshold may be implemented through a protocol agreement, higher-layer configuration, or the like. This is not limited herein.

(32) The first network element receives delay notification information sent by the second network element, where the delay notification information includes a transmission delay of the at least one computing node. Correspondingly, the first network element may save the received transmission delay of the at least one computing node, or update the saved transmission delay of the at least one computing node based on the received transmission delay, for use in determining a subsequent target computing node.

For the foregoing (31) and (32), the transmission delay of the at least one computing node may be actively obtained by the first network element from the second network element. For example, the first request is sent. Alternatively, the second network element may also actively send the transmission delay of the at least one computing node to the first network element, and the second network element may further send the transmission delay to the first network element after receiving the first request sent by the first network element. This is not limited herein in this embodiment.

In an implementation, when the second network element has a capability of providing a transmission delay notification of the at least one computing node, the second network element may register a delay notification subscription service of the at least one computing node with a third network element. Therefore, before sending the first request to the second network element, the first network element may send a second request to the third network element, to query whether the second network element provides the delay notification subscription service of the at least one computing node. The first network element receives a first response sent by the third network element. The first response is used for instructing the second network element to provide a delay notification subscription service of the at least one computing node. Therefore, the second network element provides the transmission delay subscription service to the first network element, so that the first network element selects a target computing node based on the subscribed transmission delay and/or processing delay, thereby effectively ensuring real-time performance and high efficiency of determining the target computing node.

The third network element may also be referred to as a Network Repository Function (NRF).

Further, in addition to the foregoing Implementation 1 to Implementation 3, in a possible implementation, the first network element may further receive and save a transmission delay of the at least one computing node sent by the second network element. In this case, if the first network element receives a computing resource usage request sent by a terminal, the first network element may first locally query whether a transmission delay of the at least one computing node corresponding to the computing resource usage request is stored. If so, a target computing node may be directly determined based on the processing delay and/or the transmission delay of the at least one computing node. If not, the target computing node may be determined based on the foregoing Implementation 1 or Implementation 2. In this way, the terminal may further improve flexibility and real-time performance of the process of determining the target computing node while minimizing the overall delay when using computing resources.

S320: The first network element determines a computing resource reservation process based on the target computing node.

It may be understood that for an implementation process of S320, reference may be made to the related descriptions in the method embodiment 200. In a possible implementation, the determining the computing resource reservation process by the first network element based on the target delay of the target computing node and the computing requirement (such as a delay requirement) of the terminal may include any one of the following (41)-(43).

(41) Perform the computing resource reservation process based on the target computing node when the computing requirement of the terminal includes a delay requirement and the target delay of the target computing node satisfies the delay requirement.

(42) Send third information to the terminal when the computing requirement of the terminal includes the delay requirement but the target delay of the target computing node does not satisfy the delay requirement, where the third information includes information about a failure of a computing request and a reason for the failure of the computing request.

The information about a failure of a computing request is used for notifying the terminal that the computing request failed. In addition, the reason for the failure of the computing request may include at least one of the following (a)-(e), so that the terminal can more accurately request a computing resource based on the reason for the failure of the computing request.
(a) No at least one computing node of the computing resource is provided;
(b) A user does not have authorization to use the computing resource.
(c) Available resources on the at least one computing node are insufficient.
(d) The delay requirement of the terminal is not satisfied.
(e) Reservation of the computing resource failed.

In an implementation, when the failure reason includes that the available resources on the at least one computing node are insufficient, the third information may further include a fallback time, and the fallback time is used for indicating that after the fallback time, the first network element may provide a computing resource for the terminal, so that the terminal may attempt to request a computing resource again after the fallback time when the terminal still has a computing requirement.

(43) Perform the computing resource reservation process based on the target computing node when the computing requirement of the terminal does not include the delay requirement.

In this embodiment, it is determined, through the delay requirement in the computing requirement provided in the foregoing (41)-(43), whether to perform a computing resource reservation process, so that accuracy of the computing resource determined for the terminal can be further ensured, thereby minimizing the overall delay when the terminal uses the computing resource.

Further, when the first network element determines to perform the computing resource reservation process, the first network element may send fourth information to the second network element, so that the second network element determines a target network element based on the identifier of the target computing node carried in the fourth information. The target network element is a network element among a plurality of fourth network elements that minimizes the transmission delay of the target computing node. In this embodiment, the fourth information may further include an IP address of the target computing node, and the like. This is not limited herein.

Furthermore, in addition to sending the foregoing fourth information, the first network element may further send fifth information to the terminal as a computing resource response to notify a node identifier of the at least one computing node reserved for the terminal, a computing resource specification, an available time for the computing resource, and the like. This is not limited herein.

It should be noted that a signaling plane or a user plane may be used for control of a computing network corresponding to the solution of determining the computing resource provided in embodiments of this application. This is not limited herein in this embodiment.

Correspondingly, the first information, the second information, the third information, and the fourth information mentioned in embodiments may be carried in a plurality of manners. For example, the first information may be carried through a computing resource delay obtaining request, the second information may be carried through a computing resource delay obtaining response, and the fourth information may be carried through a separate computing resource reservation notification, or may be carried by multiplexing another message between the first network element and the second network element. This is not limited herein in this embodiment.

In this embodiment, several different manners of determining a computing resource are provided, which not only can minimize the overall delay of the terminal when the terminal uses the computing resource, but also can ensure flexibility of determining the computing resource.

Further, based on the descriptions of the foregoing method embodiments 200-300, a process of determining a computing resource provided in this application is further described below through examples 1-3, and the content is as follows.

### Example 1

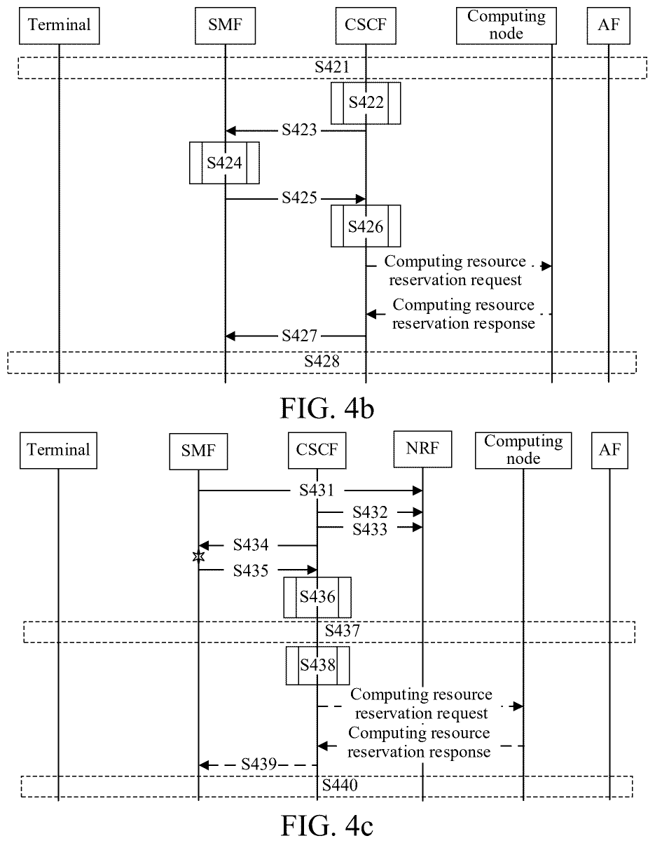

As shown in FIG. 4a, assuming that the first network element does not obtain a transmission delay of at least one computing node, a process of determining a target computing node by the first network element is shown in the following S411-S418. It is assumed that the first network element is a CSCF, the second network element is an SMF, the third network element is an NRF, and the fourth network element is a UPF.

S411: The terminal sends a computing resource usage request to request to use a computing resource.

The computing resource usage request carries a computing requirement, such as a delay requirement. If a signaling plane control is used for control, the computing requirement may be transferred by the SMF to the CSCF. If a user plane is used for control, the computing requirement may be transferred from the AF to the CSCF through the NRF.

S412: The CSCF preselects the at least one computing node based on state information of the computing node and a computing requirement of the terminal, which can satisfy the computing requirement of the terminal. If no CR can satisfy the computing requirement of the terminal, a computing resource response is sent to the terminal, to notify the terminal of a request failure and a failure reason, and the process is terminated.

S413: The CSCF sends first information to the SMF, where the first information includes a node identifier and/or a processing delay of the preselected at least one computing node.

S414: The SMF queries for each locally stored transmission delay (such as a first interface delay and a second interface delay) after receiving the second information, and obtains, from the preselected computing nodes based on a processing delay of the at least one computing node of the first information, a target computing node having a minimum target delay (a transmission delay+a processing delay).

S415: The SMF sends second information to the CSCF, where the second information may include, but is not limited to, a node identifier and a target delay of a target computing node.

S416: If the computing requirement of the terminal includes a delay requirement, the CSCF compares a target delay domain of the target computing node carried in the second information with the delay requirement of the terminal, and if the target delay domain is greater than the delay requirement of the terminal, no computing node can satisfy the computing requirement of the terminal, that is, reservation of the computing resource failed, and the process is terminated. Otherwise, the CSCF performs the computing resource reservation process based on the target computing node carried in the second information.

S417: The CSCF notifies the SMF of a target computing node with successful resource reservation, so that the SMF selects a UPF corresponding to a minimum delay through a node identifier of the at least one computing node.

S418: The CSCF sends a computing resource response to the terminal, where the computing resource response may be third information sent when the reservation of the computing resource failed, to notify the terminal of a request failure and a failure reason, or may be related information of the computing resource when the computing resource reservation succeeds, such as an identifier, a resource type, or a resource specification of the target computing node.

### Example 2

As shown in FIG. 4b, assuming that the first network element does not obtain a transmission delay of at least one computing node, a process of determining a target computing node by the first network element is shown in the following S421-S428. It is assumed that the first network element is a CSCF, the second network element is an SMF, the third network element is an NRF, and the fourth network element is a UPF.

S421: The terminal sends a computing resource usage request to request to use a computing resource.

The computing resource usage request carries a computing requirement, such as a delay requirement. If a signaling plane control is used for control, the computing requirement may be transferred by the SMF to the CSCF. If a user plane is used for control, the computing requirement may be transferred from the AF to the CSCF through the NRF.

S422: The CSCF preselects the at least one computing node based on state information of the at least one computing node and a computing requirement of the terminal, which can satisfy the computing requirement of the terminal. If no CR can satisfy the computing requirement of the terminal, a computing resource response is sent to the terminal, to notify the terminal of a request failure and a failure reason, and the process is terminated.

S423: The CSCF sends first information to the SMF, where the first information includes a node identifier and/or a processing delay of the preselected computing node.

S424: The SMF queries for each locally stored transmission delay (such as a first interface delay and a second interface delay) after receiving the second information. For each preselected computing node, when the first information includes a processing delay of the preselected computing node, the SMF calculates a target delay based on a sum of the processing delay and the queried transmission delay. When the first information does not include the processing delay of the preselected computing node, the SMF calculates the target delay based on the transmission delay.

S425: The SMF sends second information to the CSCF, where the second information includes a node identifier of each preselected computing node, the target delay, and an order of magnitudes of target delays of the preselected computing nodes.

S426: The CSCF obtains a target delay of each preselected computing node based on the second information received from the SMF, and selects a preselected computing node having a minimum target delay as a target computing node. In addition, if the target computing node is determined by the SMF based on the transmission delay, the CSCF may update the target delay based on a sum of the target delay and the processing delay.

If the computing requirement of the terminal includes a delay requirement, the CSCF compares a target delay domain of the target computing node carried in the second information of the updated target delay with the delay requirement of the terminal, and if the target delay domain is greater than the delay requirement of the terminal, no computing node can satisfy the computing requirement of the terminal, that is, the reservation of the computing resource failed, and the process is terminated. Otherwise, the CSCF performs the computing resource reservation process based on the target computing node carried in the second information.

S427: The SMF is notified of a target computing node with successful resource reservation, so that the SMF selects a UPF corresponding to a minimum delay through CR information.

S428: The CSCF sends a computing resource response to the terminal, where the computing resource response may be third information sent when the reservation of the computing resource failed, to notify the terminal of a request failure and a failure reason, or may be related information of the computing resource when the computing resource reservation succeeds, such as an identifier, a resource type, or a resource specification of the target computing node.

### Example 3

As shown in FIG. 4c, assuming that the first network element does not obtain a transmission delay of at least one computing node, a process of determining a target computing node by the first network element is shown in the following S431-S440. It is assumed that the first network element is a CSCF, the second network element is an SMF, the third network element is an NRF, and the fourth network element is a UPF.

S431: The SMF having a transmission delay notification capability registers a delay notification subscription service with the NRF.

S432: The CSCF sends a second request to the NRF, to query whether the SMF provides a delay notification subscription service of the at least one computing node.

S433: The NRF sends a first response to the CSCF, to instruct the SMF to provide the delay notification subscription service of the at least one computing node.

S434: The CSCF sends a first request to the SMF, to subscribe to a delay notification service of the at least one computing node and clarify a list of subscribed CRs, where parameters include, but are not limited to, a CR identifier, a notification period, a first threshold (which may also be referred to as a floating threshold value), a second threshold, and the like.

S435: The SMF sends delay notification information to the CSCF based on the first request, to notify the CSCF of a transmission delay of a subscribed computing node.

S436: The CSCF updates a transmission delay of each computing node in the notification after receiving the delay notification information.

S437: The terminal sends a computing resource usage request to request to use a computing resource.

The computing resource usage request carries a computing requirement, such as a delay requirement. If a signaling plane control is used for control, the computing requirement may be transferred by the SMF to the CSCF. If a user plane is used for control, the computing requirement may be transferred from the AF to the CSCF through the NRF.

S438: The CSCF selects, as a target computing node based on state information of the at least one computing node, a target delay (a transmission delay+a processing delay) of the at least one computing node, and a computing requirement of the terminal, the at least one computing node satisfying the computing requirement of the terminal and having a minimum target delay.

If the computing requirement of the terminal includes the delay requirement, the minimum overall delay of the CR is compared with the delay requirement of the terminal. When the minimum overall delay is greater than the delay requirement of the terminal, it indicates that no CR can satisfy the computing delay requirement of the terminal, that is, the reservation of the computing resource failed. Third information (that is, a computing resource response) is sent to the terminal, the terminal is notified of a request failure and a failure reason, and the process is terminated. On the contrary, the CSCF performs a computing resource reservation process based on the target computing node.

S439: The CSCF notifies the SMF of a target computing node with successful resource reservation, so that the SMF selects a UPF corresponding to a minimum delay through CR information.

S440: The CSCF sends a computing resource response to the terminal.

It may be understood that the examples 1-3 may include, but are not limited to, the foregoing steps, and for specific implementation process thereof, reference may be made to the specific description of the foregoing method embodiments 200-300, and the same or corresponding technical effects may be achieved. To avoid repetition, details are not described herein again.

In a schematic flowchart of a method 500 for determining a computing resource according to an exemplary embodiment of this application, the method 500 may be performed by, but not limited to, a second network element, and may be specifically performed by hardware and/or software installed in the second network element. In this embodiment, the method 500 may include at least the following S510 and/or S520.

S510: A second network element receives first information sent by a first network element, and sends second information to the first network element.

The first information includes at least an identifier and/or a processing delay of at least one preselected computing node, and the second information includes at least a node identifier and a target delay of a target computing node, and/or the second information includes a node identifier and a target delay of each preselected computing node, where the target computing node is a computing node having a minimum target delay among the at least one preselected computing node.

S520: The second network element provides delay notification information for the first network element, where the delay notification information includes a transmission delay of the at least one computing node.

Optionally, the target delay satisfies any one of the following: when the first information comprises a processing delay of the preselected computing node, the target delay is determined based on the processing delay and the transmission delay of the at least one computing node; and when the first information does not comprise the processing delay of the preselected computing node, the target delay is determined based on the transmission delay.

Optionally, the second information further includes an arrangement order of each preselected computing node, and the arrangement order is determined based on a magnitude of the target delay.

Optionally, before the providing delay notification information for the first network element, the method further includes: receiving a first request sent by the first network element, where the first request is used for subscribing to a delay notification service of the at least one computing node.

Optionally, the first request includes at least one of a delay notification period of the at least one computing node, a first threshold, and a second threshold, the first threshold is used for indicating that delay notification is performed when a transmission delay variation of the at least one computing node exceeds the first threshold, and the second threshold is used for indicating that the delay notification information is sent when the transmission delay of the at least one computing node exceeds the second threshold.

Optionally, the method further includes: registering a delay notification subscription service of the at least one computing node with a third network element.

Optionally, the method further includes: receiving fourth information sent by the first network element, where the fourth information carries an identifier of the target computing node; and determining a target network element based on the identifier of the target computing node, where the target network element is a network element among a plurality of fourth network elements that minimizes the transmission delay of the target computing node.

Optionally, the transmission delay includes a first interface delay and a second interface delay, the first interface delay is a transmission delay between a radio access network element and a fourth network element, and the second interface delay is a transmission delay between the fourth network element and the at least one computing node.

It may be understood that because the method embodiment 500 has the same or corresponding technical features as the foregoing method embodiments 200-300, for the implementation process of this method embodiment 500, reference may be made to the related description of the foregoing method embodiments 200-300. To avoid repetition, details are not described herein again.

In this embodiment, the second network element determines a target computing node from the received at least one preselected computing node sent by the first network element, or the second network element determines a target delay of each preselected computing node sent by the first network element, and sends a result of the determination to the first network element to perform a computing resource reservation process. Therefore, through comprehensive consideration of the parameter, that is, the delay information of the at least one computing node, a computing resource having a minimum delay can be further selected, thereby further optimizing the computing network resource to reduce the network delay and then improve communication performance.

Additionally/alternatively, the second network element performs a computing resource reservation process by providing a transmission delay of the at least one computing node for the first network element. Therefore, through comprehensive consideration of the parameter, that is, the delay information of the at least one computing node, a computing resource having a minimum delay can be further selected, thereby further optimizing the computing network resource to reduce the network delay and then improve communication performance.

The methods 200-500 for determining a computing resource provided in embodiments of this application may be performed by an apparatus for determining a computing resource. In embodiments of this application, an apparatus for determining a computing resource provided in embodiments of this application is described by using an example in which the apparatus for determining a computing resource performs the method for determining a computing resource.

As shown in FIG. 6, FIG. 6 is a schematic structural diagram of an apparatus 600 for determining a computing resource according to an exemplary embodiment of this application. The apparatus 600 includes: a first determining module 610, configured to determine a target computing node from at least one computing node based on delay information of the at least one computing node; and a second determining module 620, configured to determine a computing resource reservation process based on the target computing node.

Optionally, the delay information of the at least one computing node includes a transmission delay and/or a processing delay.

Optionally, the determining, by the first determining module 610, a target computing node from at least one computing node based on delay information of the at least one computing node includes: determining at least one preselected computing node from the at least one computing node based on state information of the at least one computing node and/or a computing requirement of a terminal; sending first information to a second network element, where the first information includes a node identifier and/or a processing delay of the at least one preselected computing node; and receiving second information sent by the second network element, where the second information includes at least a node identifier and a target delay of the target computing node, and/or the second information includes a node identifier and a target delay of each preselected computing node, and the target computing node is a computing node having a minimum target delay among the at least one preselected computing node.

Optionally, the determining, by the first determining module 610, a target computing node from at least one computing node based on delay information of the at least one computing node further includes any one of the following: determining a preselected computing node having a minimum target delay as the target computing node when the first information includes the processing delay and the second information includes the node identifier and the target delay of each preselected computing node; and updating, for each preselected computing node when the first information does not include the processing delay and the second information includes the node identifier and the target delay of each preselected computing node, the target delay of the preselected computing node based on a sum of the processing delay and the target delay of the preselected computing node, and determining the updated preselected computing node having a minimum target delay as the target computing node.

Optionally, the second information includes an arrangement order of each preselected computing node, and the arrangement order is determined based on a magnitude of the target delay.

Optionally, the target delay is determined based on the processing delay and the transmission delay of the at least one computing node. Alternatively, the target delay is determined based on the transmission delay.

Optionally, the apparatus further includes a transmission module, configured to perform at least one of the following: sending a first request to the second network element when the delay information of the at least one computing node includes a transmission delay, where the first request is used for subscribing to a delay notification service of the at least one computing node; and receiving delay notification information sent by the second network element, where the delay notification information includes a transmission delay of the at least one computing node.

Optionally, the transmission delay includes a first interface delay and a second interface delay, the first interface delay is a transmission delay between a radio access network element and a fourth network element, and the second interface delay is a transmission delay between the fourth network element and the at least one computing node.

Optionally, the first request further includes at least one of a delay notification period of the at least one computing node, a first threshold, and a second threshold, the first threshold is used for indicating that the delay notification information is sent when a transmission delay variation of the at least one computing node exceeds the first threshold, and the second threshold is used for indicating that the delay notification information is sent when the transmission delay of the at least one computing node exceeds the second threshold.

Optionally, before sending the first request to the second network element, the apparatus further includes: sending a second request to a third network element, where the second request is used for querying whether the second network element provides a delay notification subscription service for the at least one computing node; and receiving a first response sent by the third network element, where the first response is used for instructing the second network element to provide the delay notification subscription service for the at least one computing node.

Optionally, the determining, by the second determining module 620, a computing resource reservation process based on the target computing node includes: determining the computing resource reservation process based on the target delay of the target computing node and the computing requirement of the terminal.

Optionally, the determining, by the second determining module 620, the computing resource reservation process based on the target delay of the target computing node and the computing requirement of the terminal includes any one of the following: performing the computing resource reservation process based on the target computing node when the computing requirement of the terminal includes a delay requirement and the target delay of the target computing node satisfies the delay requirement; sending third information to the terminal when the computing requirement of the terminal includes the delay requirement but the target delay of the target computing node does not satisfy the delay requirement, where the third information includes information about a failure of a computing request and a reason for the failure of the computing request; and performing the computing resource reservation process based on the target computing node when the computing requirement of the terminal does not include the delay requirement.

Optionally, the reason for the failure of the computing request includes at least one of the following: no at least one computing node of the computing resource is provided; a user does not have authorization to use the computing resource; available resources on the at least one computing node are insufficient; the delay requirement of the terminal is not satisfied; and reservation of the computing resource failed.

Optionally, when the failure reason includes that the available resources on the at least one computing node are insufficient, the third information further includes a fallback time, and the fallback time is used for indicating that after the fallback time, the first network element is able to provide a computing resource for the terminal.

Optionally, the transmission module is further configured to send fourth information to the second network element when the computing resource reservation process is performed, where the fourth information carries an identifier of the target computing node.

As shown in FIG. 7, FIG. 7 is a schematic structural diagram of an apparatus 700 for determining a computing resource according to an exemplary embodiment of this application. The apparatus 700 includes: a transmission module 710, configured to perform at least one of the following: receiving, by a second network element, first information sent by a first network element, where the first information includes at least an identifier and/or a processing delay of at least one preselected computing node, and sending second information to the first network element, where the second information includes at least a node identifier and a target delay of a target computing node, and/or the second information includes a node identifier and a target delay of each preselected computing node, and the target computing node is a computing node having a minimum target delay among the at least one preselected computing node; and providing delay notification information for the first network element, where the delay notification information includes the transmission delay of the computing node.

Optionally, the target delay satisfies any one of the following: when the first information includes a processing delay of the preselected computing node, the target delay is determined based on the processing delay and the transmission delay of the computing node; and when the first information does not comprise the processing delay of the preselected computing node, the target delay is determined based on the transmission delay.

Optionally, the second information further includes an arrangement order of each preselected computing node, and the arrangement order is determined based on a magnitude of the target delay.

Optionally, before providing the delay notification information for the first network element, the transmission module 710 is further configured to: receive a first request sent by the first network element, where the first request is used for subscribing to a delay notification service of the computing node.

Optionally, the first request includes at least one of a delay notification period of the computing node, a first threshold, and a second threshold, the first threshold is used for indicating that delay notification is performed when a transmission delay variation of the computing node exceeds the first threshold, and the second threshold is used for indicating that the delay notification information is sent when the transmission delay of the computing node exceeds the second threshold.

Optionally, the apparatus 700 further includes: registering a delay notification subscription service of the computing node with a third network element.

Optionally, the transmission module 710 is further configured to receive fourth information sent by the first network element, where the fourth information carries an identifier of the target computing node. The apparatus further includes a determining module, configured to determine a target network element based on the identifier of the target computing node, where the target network element is a network element among a plurality of fourth network elements that minimizes the transmission delay of the target computing node.

Optionally, the transmission delay includes a first interface delay and a second interface delay, the first interface delay is a transmission delay between a radio access network element and a fourth network element, and the second interface delay is a transmission delay between the fourth network element and the computing node.

The apparatuses 600-700 for determining a computing resource in embodiments of this application may be each an electronic device, for example, an electronic device having an operating system, or may be a component in the electronic device, for example, an integrated circuit or a chip. The electronic device may be a network side device. For example, the network side device may include but not limited to the type of the network side device 12 listed above. This is not specifically limited in embodiments of this application.

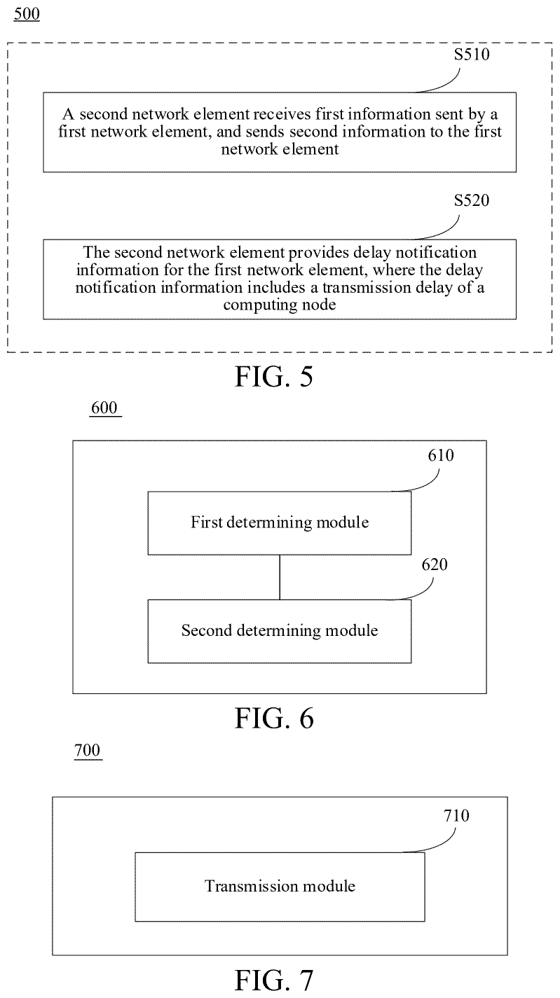

The apparatuses 600-700 for determining a computing resource provided in embodiments of this application can implement all processes implemented in the method embodiments of FIG. 2 to FIG. 5, and achieve the same technical effect. To avoid repetition, details are not described herein again.

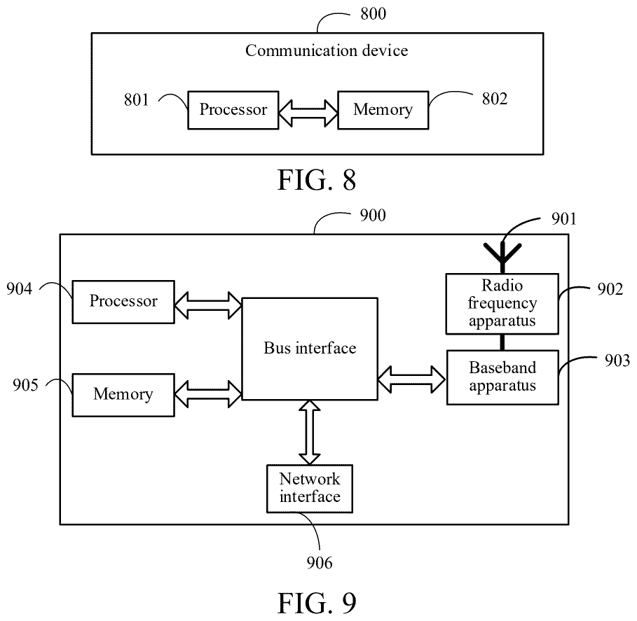

Optionally, as shown in FIG. 8, an embodiment of this application further provides a communication device 800, including a processor 801 and a memory 802. The memory 802 stores a program or an instruction executable on the processor 801. For example, when the communication device 800 is a terminal, the program or the instruction, when executed by the processor 801, implements the steps of embodiments of the foregoing method for determining a computing resource, and can achieve the same technical effect. When the communication device 800 is a network side device, the program or the instruction, when executed by the processor 801, implements the steps of embodiments of the foregoing method for determining a computing resource, and can achieve the same technical effect. To avoid repetition, details are not described herein again.

An embodiment of this application further provides a network side device, including a processor and a communication interface. The communication interface is coupled to the processor, and the processor is configured to run a program or an instruction to implement the steps of the method embodiments 200-500. The network side device embodiment corresponds to the foregoing method embodiment of the network side device. The implementation processes and implementations of the foregoing method embodiments are all applicable to the network side device embodiment, and can achieve the same technical effect.

Specifically, an embodiment of this application further provides a network side device. As shown in FIG. 9, a network side device 900 includes: an antenna 901, a radio frequency apparatus 902, a baseband apparatus 903, a processor 904, and a memory 905. The antenna 901 is connected to the radio frequency apparatus 902. In an uplink direction, the radio frequency apparatus 902 receives information through the antenna 901, and sends the received information to the baseband apparatus 903 for processing. In a downlink direction, the baseband apparatus 903 processes to-be-sent information, and sends the processed to-be-sent information to the radio frequency apparatus 902. The radio frequency apparatus 902 processes the received information, and then sends the processed information through the antenna 901.

The method performed by the network side device in the foregoing embodiment may be implemented by the baseband apparatus 903. The baseband apparatus 903 includes a baseband processor.

The baseband apparatus 903 may include, for example, at least one baseband board. A plurality of chips are arranged on the baseband board, as shown in FIG. 9. One of the chips is for example a baseband processor, and is connected to the memory 905 through a bus interface to call a program in the memory 905 and perform the operations of the network device shown in the foregoing method embodiment.

The network side device may further include a network interface 906. The interface is, for example, a common public radio interface (common public radio interface, CPRI).

Specifically, the network side device 900 in this embodiment of this application further includes an instruction or a program stored in the memory 905 and executable by the processor 904. The processor 904 invokes the instruction or the program in the memory 905 to perform the method performed by each module shown in FIG. 6 or FIG. 7, and achieves the same technical effect. To avoid repetition, details are not described herein.

An embodiment of this application further provides a readable storage medium. The readable storage medium stores a program or an instruction. The program or the instruction, when executed by a processor, implements the processes of embodiments of the method for determining a computing resource, and can achieve the same technical effect. To avoid repetition, details are not described herein again.

The processor is a processor in the terminal described in the foregoing embodiments. The readable storage medium includes a computer-readable storage medium, such as a computer read-only memory ROM, a random access memory RAM, a magnetic disk, or an optical disk.

An embodiment of this application further provides a chip. The chip includes a processor and a communication interface. The communication interface is coupled to the processor. The processor is configured to run a program or an instruction of a network side device, to implement the processes of embodiments of the foregoing method for determining a computing resource, and can achieve the same technical effect. To avoid repetition, details are not described herein again.

It should be understood that the chip mentioned in this embodiment of this application may further be referred to as a system level chip, a system chip, a chip system, a system on chip, or the like.

An embodiment of this application further provides a computer program product. The computer program product includes a processor, a memory, and a program or an instruction stored in the memory and executable on the processor. The program or the instruction, when executed by the processor, implements the processes of embodiments of the foregoing method for determining a computing resource, and can achieve the same technical effect. To avoid repetition, details are not described herein again.

An embodiment of this application further provides a wireless communication system, including: a terminal and a network side device. The network side device may be configured to implement the processes of embodiments of the foregoing method for determining a computing resource during execution, and can achieve the same technical effect. To avoid repetition, details are not described herein again.

It should be noted that a term “comprise”, “include” or any other variant herein are intended to encompass non-exclusive inclusion, so that a process, a method, an article, or an apparatus including a series of elements not only includes those elements, but also includes another element not listed explicitly, or includes intrinsic elements for the process, the method, the article, or the apparatus. Without any further limitation, an element defined by the phrase “include one . . . ” does not exclude existence of an additional same element in the process, the method, the article, or the apparatus that includes the element. In addition, it should be noted that the scope of the method and the apparatus in embodiments of this application is not limited to function execution in the order shown or discussed, and may further include function execution in a substantially simultaneous manner or in the opposite order based on the functions. For example, the described method may be performed in different order from the described order, and various steps may also be added, omitted, or combined. In addition, features described with reference to some examples may be combined in another example.

Through the descriptions of the foregoing implementations, a person skilled in the art may clearly learn that the method in the foregoing embodiments may be implemented by software with a necessary universal hardware platform, or may be implemented by hardware. However, in many cases, the software with a necessary universal hardware platform is a preferred implementation. Based on such an understanding, the technical solution of this application, in essence, or a part contributing to the prior art may be embodied in a form of a computer software product. The computer software product is stored in a storage medium (such as a ROM/RAM, a magnetic disk, or an optical disk), including several instructions for causing a terminal (such as a mobile phone, a computer, a server, an air conditioner, or a network device) to perform the method in embodiments of this application.

Although embodiments of this application are described above with reference to the accompanying drawings, this application is not limited to the specific implementations described above. The foregoing specific implementations are illustrative but not restrictive. With the enlightenment of this application, a person of ordinary skill in the art may make many forms without departing from the concept of this application and the protection scope of the claims. These forms fall within the protection of this application.

What is claimed is:

1. A method for determining a computing resource, comprising:
determining, by a first network element, a target computing node from at least one computing node based on delay information of the at least one computing node; and
determining a computing resource reservation process based on the target computing node.

2. The method according to claim 1, wherein the delay information of the at least one computing node comprises at least one of a transmission delay or a processing delay.

3. The method according to claim 2, wherein the determining a target computing node from at least one computing node based on delay information of the at least one computing node comprises:
determining at least one preselected computing node from the at least one computing node based on at least one of state information of the at least one computing node or a computing requirement of a terminal;
sending first information to a second network element, wherein the first information comprises at least one of a node identifier or a processing delay of the at least one preselected computing node; and
receiving second information sent by the second network element, wherein the second information comprises at least a node identifier and a target delay of the target computing node, and/or the second information comprises a node identifier and a target delay of each preselected computing node, and the target computing node is a computing node having a minimum target delay among the at least one preselected computing node.

4. The method according to claim 3, wherein the determining a target computing node from at least one computing node based on delay information of the at least one computing node further comprises any one of the following:
determining a preselected computing node having a minimum target delay as the target computing node when the first information comprises the processing delay and the second information comprises the node identifier and the target delay of each preselected computing node; and
updating, for each preselected computing node when the first information does not comprise the processing delay and the second information comprises the node identifier and the target delay of each preselected computing node, the target delay of the preselected computing node based on a sum of the processing delay and the target delay of the preselected computing node, and determining the updated preselected computing node having a minimum target delay as the target computing node.

5. The method according to claim 2, wherein the delay information of the at least one computing node comprises the transmission delay, and the method further comprises at least one of the following:
sending a first request to a second network element, wherein the first request is used for subscribing to a delay notification service of the at least one computing node; and
receiving delay notification information sent by the second network element, wherein the delay notification information comprises a transmission delay of the at least one computing node.

6. The method according to claim 2, wherein the transmission delay comprises a first interface delay and a second interface delay, the first interface delay is a transmission delay between a radio access network element and a fourth network element, and the second interface delay is a transmission delay between the fourth network element and the at least one computing node.

7. The method according to claim 5, wherein the first request further comprises at least one of a delay notification period of the at least one computing node, a first threshold, and a second threshold, the first threshold is used for indicating that the delay notification information is sent when a transmission delay variation of the at least one computing node exceeds the first threshold, and the second threshold is used for indicating that the delay notification information is sent when the transmission delay of the at least one computing node exceeds the second threshold.

8. The method according to claim 5, wherein before the sending a first request to a second network element, the method further comprises:
sending a second request to a third network element, wherein the second request is used for querying whether the second network element provides a delay notification subscription service for the at least one computing node; and
receiving a first response sent by the third network element, wherein the first response is used for instructing the second network element to provide the delay notification subscription service for the at least one computing node.

9. The method according to claim 1, wherein the determining a computing resource reservation process based on the target computing node comprises:
determining the computing resource reservation process based on the target delay of the target computing node and the computing requirement of the terminal.

10. The method according to claim 9, wherein the determining the computing resource reservation process based on the target delay of the target computing node and the computing requirement of the terminal comprises any one of the following:
performing the computing resource reservation process based on the target computing node when the computing requirement of the terminal comprises a delay requirement and the target delay of the target computing node satisfies the delay requirement;
sending third information to the terminal when the computing requirement of the terminal comprises the delay requirement but the target delay of the target computing node does not satisfy the delay requirement, wherein the third information comprises information about a failure of a computing request and a reason for the failure of the computing request; and
performing the computing resource reservation process based on the target computing node when the computing requirement of the terminal does not comprise the delay requirement.

11. The method according to claim 10, wherein the reason for the failure of the computing request comprises at least one of the following:
no at least one computing node of the computing resource is provided;
a user does not have authorization to use the computing resource;
available resources on the at least one computing node are insufficient;
the delay requirement of the terminal is not satisfied; and
reservation of the computing resource failed,
wherein when the reason for failure of the computing request comprises that the available resources on the at least one computing node are insufficient, the third information further comprises a fallback time, and the fallback time is used for indicating that after the fallback time, the first network element is configured to provide a computing resource for the terminal.

12. The method according to claim 10, further comprising:
sending fourth information to the second network element when the computing resource reservation process is performed, wherein the fourth information carries an identifier of the target computing node.

13. A method for determining a computing resource, comprising at least one of the following:
receiving, by a second network element, first information sent by a first network element, wherein the first information comprises at least one of an identifier or a processing delay of at least one preselected computing node, and sending second information to the first network element, wherein the second information comprises at least a node identifier and a target delay of a target computing node, and/or the second information comprises a node identifier and a target delay of each preselected computing node, and the target computing node is a computing node having a minimum target delay among the at least one preselected computing node; and
providing, by the second network element, delay notification information for the first network element, wherein the delay notification information comprises a transmission delay of the computing node.

14. The method according to claim 13, wherein the target delay satisfies any one of the following:
when the first information comprises a processing delay of the preselected computing node, the target delay is determined based on the processing delay and the transmission delay of the computing node; and
when the first information does not comprise the processing delay of the preselected computing node, the target delay is determined based on the transmission delay.

15. The method according to claim 13, wherein the second information further comprises an arrangement order of each preselected computing node, and the arrangement order is determined based on a magnitude of the target delay.

16. The method according to claim 13, wherein before the providing delay notification information for the first network element, the method further comprises:
receiving a first request sent by the first network element, wherein the first request is used for subscribing to a delay notification service of the computing node; and
the first request comprises at least one of a delay notification period of the computing node, a first threshold, and a second threshold, the first threshold is used for indicating that delay notification is performed when a transmission delay variation of the computing node exceeds the first threshold, and the second threshold is used for indicating that the delay notification information is sent when the transmission delay of the computing node exceeds the second threshold,
wherein the method further comprises:
registering a delay notification subscription service of the computing node with a third network element.

17. The method according to claim 13, further comprising:
receiving fourth information sent by the first network element, wherein the fourth information carries an identifier of the target computing node; and
determining a target network element based on the identifier of the target computing node, wherein the target network element is a network element among a plurality of fourth network elements that minimizes the transmission delay of the target computing node.

18. The method according to claim 13, wherein the transmission delay comprises a first interface delay and a second interface delay, the first interface delay is a transmission delay between a radio access network element and a fourth network element, and the second interface delay is a transmission delay between the fourth network element and the computing node.

19. A network side device, comprising:
at least one hardware processor; and
a memory, wherein the memory stores a program or an instruction executable by the at least one hardware processor that, when executed by the at least one hardware processor, directs the at least one hardware processor to:
determine a target computing node from at least one computing node based on delay information of the at least one computing node; and
determine a computing resource reservation process based on the target computing node.

20. A network side device, comprising at least one hardware processor and a memory, wherein the memory stores a program or an instruction executable by the at least one hardware processor that, when executed by the at least one hardware processor, directs the at least one hardware processor to implement the method for determining a computing resource according to claim 13.
